(19) United States
(12) Patent Application Publication
(10) Pub. No.: US 2010/0205250 A1
(43) Pub. Date: Aug. 12, 2010

(54) Peer-to-peer network

(76) Inventors: Edward O'Brien Wolf, Fairport, NY (US); Frederick Collin Davidson, Apex, NC (US); Richard Krueger, Cary, NC (US); Guy Richard Beretich, JR., Clinton, NC (US)

Correspondence Address: Richard Krueger, 106A Fountainbrook Circle, Cary, NC, 27511, US

(21) Appl. No.: 12/322,034

(22) Filed: Jan. 28, 2009

(51) Int. Cl. G06F 15/16

(52) U.S. Cl. 709/204

(57) ABSTRACT

A peer-to-peer network enabled for folder sharing, wherein entire folders can be shared between peers.

### TECHNICAL FIELD

The present invention relates generally to computers and computer-related technology. More specifically, the present invention relates to systems and methods for sharing in a peer-to-peer network.

### BACKGROUND

Currently, the on-line photo fulfillment with storage industry is hampered because costs exceed revenues. This is because the cost of storage of photographs is excessive compared to the revenue from print fulfillment of those images. Thus, each new user that is added to the on-line system brings a net loss. Additionally, these same on-line storage systems require the user to upload photographs one-at-a-time. This method is very inconvenient and frustrating to the users.

Thus, what is needed is a system for on-line photo fulfillment that does not incur long-term storage costs. Additionally, such a system needs to be conveniently designed to allow users to upload an entire folder of images in a single upload, rather than one image at a time.

### BRIEF DESCRIPTION OF THE DRAWINGS

FIG. 1 is a block diagram illustrating some of the component parts of a peer-to-peer network configured to operate according to one embodiment of the present invention.

FIG. 2 is a diagram illustrating a peer-to-peer network according to one embodiment of the present invention.

FIG. 3 is a diagram illustrating a peer-to-peer network according to one embodiment of the present invention.

FIG. 4 is a diagram illustrating a peer-to-peer network according to one embodiment of the present invention.

### DETAILED DESCRIPTION

The present invention is directed to a peer-to-peer network having folder-sharing ability. Each peer node in the peer-to-peer network can share a folder with one or more peers in the network.

The present invention further includes the ability to drag-and-drop multiple files and folders into a shared folder.

The present invention further includes a shared service folder between at least one peer and at least one service provider peer. For example, one of the peers may provide a photo fulfillment service, wherein a customer peer shares a folder of digital images with the photo fulfillment provider and then instructs the photo fulfillment provider to print or otherwise use the digital images in any of the means currently available.

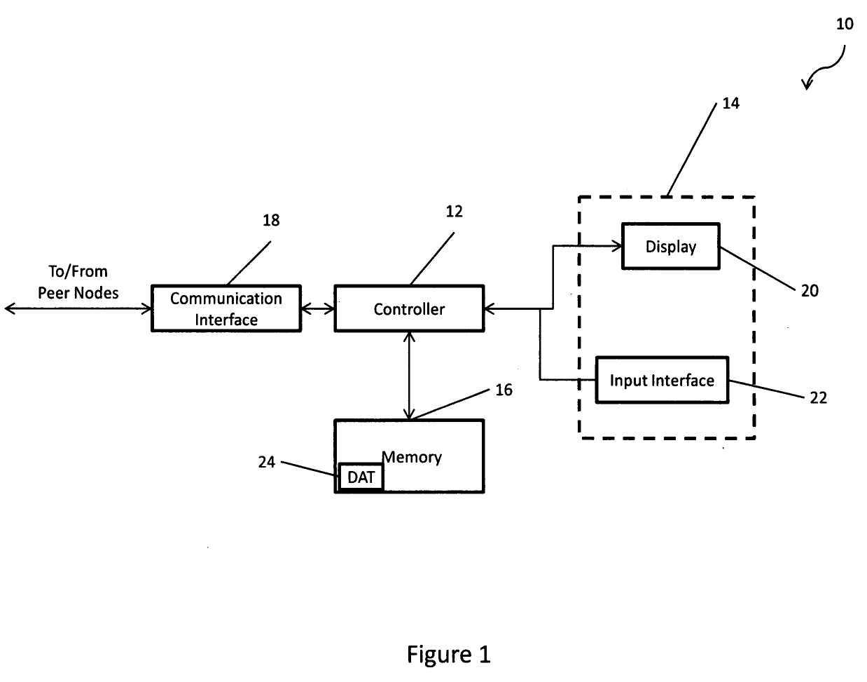

FIG. 1 illustrates some of the components of a peer node 10 configured to communicate with other peer nodes via a “gossip channel” according to one embodiment of the present invention. As used herein, a “gossip channel” may be any communication channel established between two or more peer nodes 10. As seen in FIG. 1, the peer node 10 comprises a computing device capable of communicating in a peer-to-peer network. Some examples of peer nodes that are suitable for use with the present invention include, but are not limited to, mobile communication devices such as cellular telephones, satellite telephones, and Personal Digital Assistants (PDAs), as well as laptop computers, notebook computers, and desktop computers.

Peer node 10 comprises a controller 12 that connects to a user interface 14, a memory 16, and a communication interface 18. Controller 12 comprises one or more microprocessors that control the operation of node 10 according to program instructions and data stored in memory 16. The control functions may be implemented in a single microprocessor, or in multiple microprocessors. Memory 16 may include both random access memory (RAM) and read-only memory (ROM). Executable program instructions and data required for operation of node 10 are stored in non-volatile memory, such as EPROM, EEPROM, and/or flash memory, which may be implemented as discrete or stacked devices, for example. Communication interface 18 is configured to communicate with the other peer nodes via the peer-to-peer network, or with other communication terminals, using any protocol known in the art. User interface 14 comprises a display 20 an input interface 22 to receive user input.

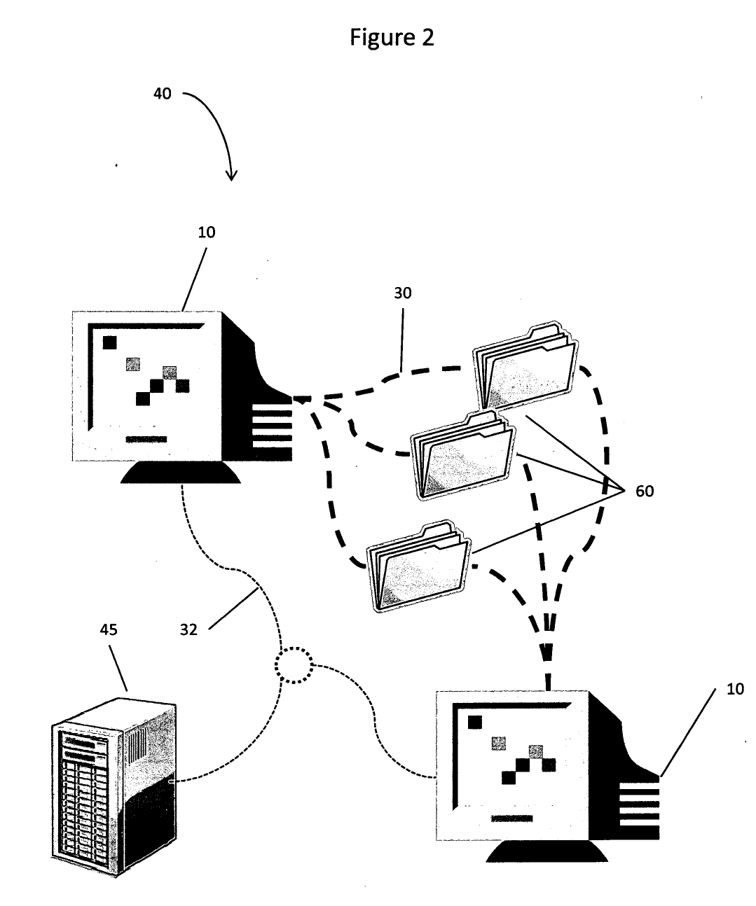

As shown in FIG. 2, the peer nodes are in communication with one another via the peer network, generally described as 40. The peer nodes 10 are placed in communication with one another by the peer network server 45. The peers 10 share an entire folder 65 with each other. The peers can import multiple files into the folder simultaneously. The peers can also perform drag-and-drop operations into the shared folder to share files. The peers can also import or drag-and-drop an entire folder into a shared folder, thus creating a shared sub-folder. The ability to use these various methods to share multiple files and folders with a single operation makes the system very useful.

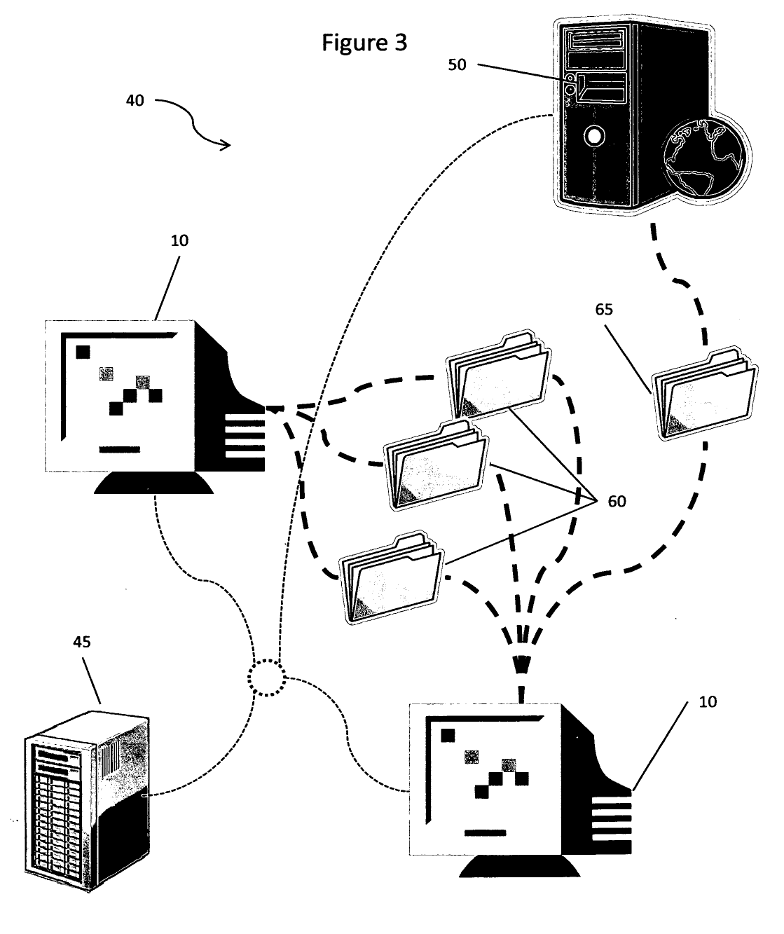

As shown in FIG. 3, one or more of the peer nodes is a service provider peer 50 that can receive service requests from customer peers. The customer peers 10 can share an entire folder 65 with the service provider peer. The peer nodes 10 and the service provider peer 50 are placed in communication with one another by the peer network server 45. The customer peer nodes 10 share folders 60 among themselves. When they desire a service, they place the files which they wish to share for service fulfillment by the service provider in a dedicated service provider folder 65. This folder may be accessible by one or more customer peers and by one or more service providers. Alternatively or additionally, a customer with a non-dedicated folder that may be shared can notify a service provider that he request to submit the contents of the folder to a service. Multiple service providers may share a folder because each of them performs one or more of the tasks associated with the service request.

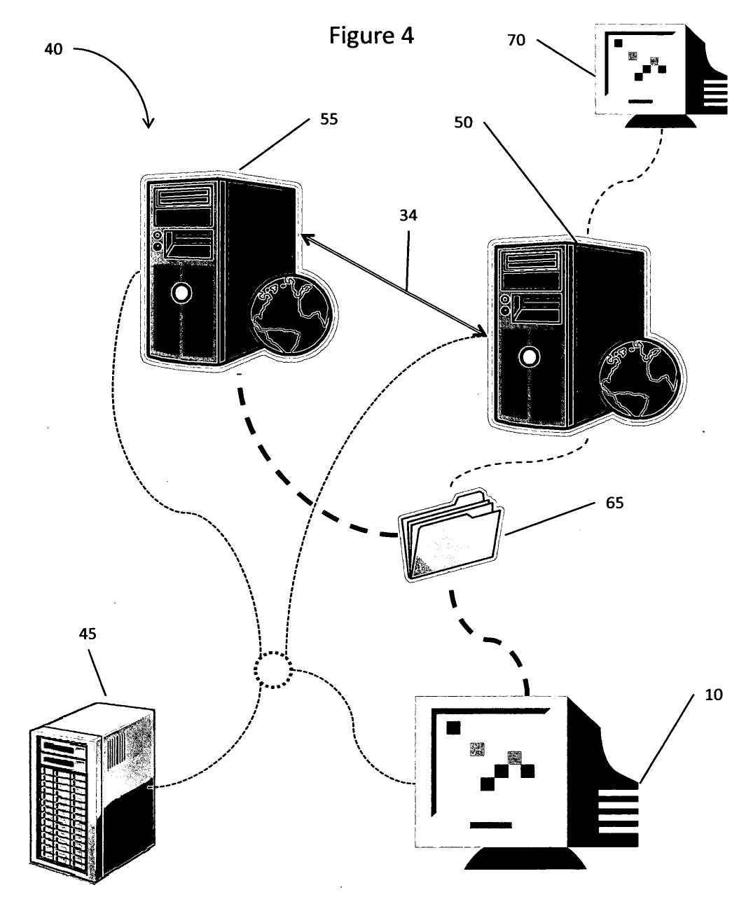

As shown in FIG. 4, two of the peer nodes are service provider peers 50 and 55 that can process service requests from customer peers. The customer peer 10 shares an entire folder 65 with the service provider peers 50 and 55. The first service provider 50 executes its task, then communicates to the second service provider via the peer network or via another data channel 34 that the job is ready to be forwarded to them such that they may execute their tasks. Such a system is advantageous, for example, where one service provider performs the product marketing and sales and another service provider performs the product manufacturing. An excellent example is the photo print fulfillment industry, where a first company provides the website to receive images and print requests and then forwards these images to a second company for the actual printing. This redundancy is an extra expense. The system and method according to the present invention permits each service provider to only gather as much file or folder data as needed to process its tasks, thus reducing bandwidth usage. For example, in the photo fulfillment industry, the first service provider is the billing agent and may gather only thumbnails and metadata information in order to calculate the cost of printing in order to invoice the customer. The second service provider may gather only the full image file needed to print or otherwise execute the printing request. Thus, the present invention reduces transmission costs where multiple service providers are needed to execute a service request.

The present invention further includes the ability of a service provider to remove heavy assets from its view of a shared folder and replace them with lighter assets that are still sufficiently representative to permit peers to make decisions regarding the assets. For example, the billing agent server described above, after having executed a first billing task, removes most of the assets from its view of the folder and replaces them with representations. For example, if the billing server had displayed the full image or the thumbnail image, it replaces them with the thumbnail or a symbolic icon, respectively.

This permits the service provider to maintain the folder for other purposes while incurring minimal storage cost. For example, the service provider can invite or otherwise solicit the purchasing customer or other service providers to invite other customers to view the shared folder for business purposes. The new viewers have access to the full file because the purchasing customer continues to maintain the full assets on its computer and thus they are available to new viewers.

The present invention further permits the service provider to present the customer's assets through different means and not incur the full storage cost. For example, as shown in FIG. 4, a photo marketer can display the thumbnails of a folder on another network 70, such as the Internet, without having to store the full image. When a customer is interested in an image and requests a higher resolution view, the photo marketer retrieves the higher resolution image from the shared folder for display. Thus, the service provider does not incur the full storage costs of a file until a customer requests it.

In such a system, where the storage costs are reduced and manageable, customers can be allowed to automatically upload their files and folders at the time they are importing them into their personal computer or otherwise generating them. This automatic uploading is very useful, since it permits the easy importing and sharing of data between peers in a way that allows viewers to immediately make a service request.

The present invention thus includes a peer-to-peer network, wherein peers can share entire folders at a time. The present invention further includes a peer-to-peer network wherein peers can drag-and-drop files and folders into a shared folder. The present invention even further includes a peer-to-peer network wherein at least one of the peers is a service provider and at least one of the shared folders is a shared service fulfillment folder. The present invention further includes two or more service providers sharing a service fulfillment request folder such that each provider can execute tasks in the service request without having to upload entire files and transfer files between service providers. The present invention further includes the ability of a peer to replace assets on their end of a shared user interface with smaller-sized representation. The present invention further includes the ability of a peer to show representations of assets in a shared folder in another communication channel. The present invention further includes the ability of peers to automatically upload files into a shared folder.

The present invention may, of course, be carried out in other ways than those specifically set forth herein without departing from essential characteristics of the invention. The present embodiments are to be considered in all respects as illustrative and not restrictive.

We claim:

1. A network system for sharing data, comprising: at least two peer nodes, each node comprising a controller that connects to a user interface, a memory, and a communication interface, the controller comprising one or more microprocessors that control the operation of its respective node according to program instructions and data stored in memory, and wherein the at least two peer nodes share a folder with each other.

2. The network system of claim 1, wherein the peers can perform drag-and-drop operations into the shared folder to share files.

3. The network system of claim 1, wherein the peers can import an entire folder into a shared folder to create a shared sub-folder.

4. The network system of claim 1, wherein the network uses a gossip channel to share data.

5. The network system of claim 1, wherein at least one peer is a service provider and the shared folder is a service fulfillment folder.

6. The network system of claim 1, wherein at least two peer nodes are service providers.

7. The network system of claim 6, wherein the at least two service providers use a gossip channel to share data.

8. The network system of claim 6, wherein at least one service provider provides a photo-fulfillment service.

9. The network system of claim 8, wherein the data comprises full image files, metadata files and thumbnail files and each service provider retrieves only the data necessary to fulfill its service.

10. A method for sharing data, the method steps comprising:
a. providing a peer-to-peer network;
b. sharing at least one folder between the peers.

11. The method of claim 10, further including the step of dragging and dropping a folder into the shared folder.

12. The method of claim 10, wherein at least one service provider is a peer.

13. The method of claim 12, wherein the network uses a gossip channel to share data.

14. The method of claim 12, wherein the at least one service provider is a photo-fulfillment service.

15. The method of claim 14, wherein the shared data comprises full image files, metadata files and thumbnail files and the method steps further include the step of the at least one service provider retrieving only the data necessary to fulfill its service.

16. A network system for sharing data, comprising: at least two peer nodes, each node comprising a controller that connects to a user interface, a memory, and a communication interface, the controller comprising one or more microprocessors that control the operation of its respective node according to program instructions and data stored in memory, and wherein the at least two peer nodes share an entire folder with each other; the peers can perform drag-and-drop operations into the shared folder to share files; the peers can import an entire folder into a shared folder to create a shared sub-folder; the network uses a gossip channel to share data; and at least one peer is a service provider and the shared folder is a service fulfillment folder.

17. The network system of claim 16, wherein at least two peer nodes are service providers.

18. The network system of claim 17, wherein at least one service provider provides a photo-fulfillment service.

19. The network system of claim 18, wherein the data comprises full image files, metadata files and thumbnail files and each service provider retrieves only the data necessary to fulfill its service.

20. The network system of claim 19, wherein the at least two service providers use a gossip channel to share data.
